(19) United States
(12) Patent Application Publication
(10) Pub. No.: US 2026/0366472 A1
(43) Pub. Date: Nov. 19, 2026

(54) METHOD FOR OPERATING A PUMP ARRANGEMENT FOR ALTERNATIVE FUELS, IN PARTICULAR FOR METHANOL OR AMMONIA, AND PUMP ARRANGEMENT

(71) Applicant: Robert Bosch GmbH, Stuttgart (DE)

(72) Inventors: Christian Graspeuntner, Hallein (AT); Michael Schwab, Schönau (DE)

(21) Appl. No.: 19/603,220

(22) PCT Filed: Dec. 23, 2024
(86) PCT No.: PCT/EP2024/088316

§ 371 Date: Aug. 7, 2026

(30) Foreign Application Priority Data
Jan. 5, 2024 (DE) 10 2024 200 122.8

(51) Int. Cl. F02M 31/20; F02M 37/00

(52) U.S. Cl. CPC F02M 31/20; F02M 37/0052; F02M 37/0064

(57) ABSTRACT

The invention relates to a method for operating a pump assembly (1) for alternative fuels, in particular for methanol or ammonia, comprising a pre-feed pump (2) and a high-pressure pump (3), wherein, with the aid of the pre-feed pump (2), fuel is supplied to at least one pump element (4) of the high-pressure pump (3) via a feed path (5) of a low-pressure circuit (6), and fuel produced by leakage in the at least one pump element (4) is discharged via a return path (7) of the low-pressure circuit (6). According to the present invention, from the feed path (5), preferably downstream of the pre-feed pump (2) and upstream of a metering unit (8) integrated in the feed path (5), fuel is branched off into a cooling path (9) and supplied to at least one cooling element (10), which is integrated into a suction chamber (11) and/or a leakage chamber (12) of the high-pressure pump (3).

The invention also relates to a pump assembly (1) for alternative fuels that is suitable for carrying out the method and operable according to the method.

### BACKGROUND

The invention relates to a method for operating a pump assembly for alternative fuels, in particular for methanol or ammonia. A pump assembly suitable for carrying out the method comprises a feed pump and a high-pressure pump. The invention further relates to a pump assembly for alternative fuel that is suitable for carrying out the method according to the invention or operable according to the method according to the invention.

A preferred area of application of the invention is engines, in particular large-scale engines, that need to be supplied with an alternative fuel.

Fuel injection systems with pump assemblies comprising a feed pump and a high-pressure pump are known from the field of internal combustion engines. Examples of the prior art are common-rail injection systems for diesel fuels that have a pump assembly with a feed pump and a high-pressure pump. The high-pressure pump of such a pump assembly often has a suction throttle. That is, only the amount of fuel that is to be brought to system pressure enters the high-pressure pump. Any leakage amounts from the pump elements of the high-pressure pump are discharged separately and remain liquid at the operating temperatures that occur even without cooling. The leakage amounts can thus be simply and usually without pressure returned to the suction side of the high-pressure pump or to the fuel tank.

One property of alternative fuels, such as methanol or ammonia, is that they change their state of matter even at comparatively low temperatures and pressures. A liquid fuel then becomes a gaseous fuel. According to the vapor curve for methanol, this occurs, for example, already at a temperature of 65 °C and ambient pressure. Because the surrounding temperature in the area of the engine to be supplied with the alternative fuel is often higher than this, this can lead to problems in the intake area of the high-pressure pump or in a leakage path for discharging the leakage amount. Furthermore, compliance with relevant safety regulations may be jeopardized as a result.

### SUMMARY

The present invention is concerned with the task of preventing the change in the state of matter of alternative fuels when conveying them to high pressure in order to avoid the associated disadvantages.

This task is solved by a method and by the pump assembly with the features of the disclosure.

A method for operating a pump assembly for alternative fuels, in particular for methanol or ammonia, comprising a feed pump and a high-pressure pump, is proposed. In the method, fuel is supplied to at least one pump element of the high-pressure pump by means of the feed pump via a feed path of a low-pressure circuit, and fuel accruing by way of leakage in the at least one pump element is discharged via a return path of the low-pressure circuit. According to the invention, fuel is branched off from the feed path into a cooling path and supplied to at least one cooling element that is integrated into a suction chamber and/or a leakage chamber of the high-pressure pump.

The fuel in the feed path is at a lower temperature than the fuel conveyed to high pressure using the high-pressure pump. The proposed method makes use of this by diverting “cool” fuel from the feed path into a cooling path and supplying it to the at least one pump element of the high-pressure pump for cooling. The cooling prevents a temperature-related change in the aggregate state of the fuel from liquid to gaseous, so that the problems described above are avoided when drawing fuel into the at least one pump element and/or recirculating fuel resulting from leakage.

The fuel diverted into the cooling path is supplied to at least one cooling element integrated into a suction chamber and/or a leakage chamber of the high-pressure pump. Preferably, a cooling element is integrated in both the suction chamber and the leakage chamber, so that cooling of the high-pressure pump and the leakage quantity is achievable. For example, the cooling path may be routed such that the fuel first flows through a cooling element integrated into the suction chamber and then through a cooling element integrated into the leakage chamber. Cooled fuel is then drawn into the at least one pump element from the suction chamber. Via the cooling element integrated into the leakage chamber, the fuel resulting from leakage in the at least one pump element can be cooled before it is discharged via the return path. An amount of fuel discharged from the feed path via a zero-delivery throttle may also be supplied to the leakage chamber and cooled prior to recirculation thereof.

The fuel provided for cooling is preferably diverted from the feed path into the cooling path downstream of the pre-feed pump and upstream of a metering unit integrated into the feed path. The metering unit is used to meter the fuel to be conveyed at high pressure. The metered fuel enters the suction chamber via the feed path and passes through the suction chamber to the at least one pump element of the high-pressure pump.

In a further development of the invention, it is proposed that the fuel diverted into the cooling path is previously cooled using a cooling device integrated into the feed path. This measure optimizes the cooling effect achieved by the diverted fuel. For example, the cooling device may be a heat exchanger integrated into a cooling circuit that is flowed through by a coolant of the cooling circuit.

Furthermore, it is proposed that the fuel diverted into the cooling path and supplied to the at least one cooling element is returned to a fuel tank or into the feed path upstream of the pre-feed pump. The fuel diverted into the cooling path is therefore not lost, but is still available for high-pressure conveyance.

Preferably, a predefined minimum pressure level is set in the return path and/or in the cooling path using a pressure-holding valve. This is above ambient pressure and is intended to ensure the liquid aggregate state of the fuel at elevated temperature. The minimum pressure level to be set is preferably selected depending on the vapor pressure curve of the particular fuel.

As a further development measure, it is suggested that fuel is branched out of the cooling path into a flush path and supplied to the at least one pump element for discharging the fuel generated by way of leakage. Flushing of the pump element promotes discharge of the amount of leakage. Further, cooling of the pump element may also be achieved. The fuel provided for purging is preferably diverted between two cooling elements from the cooling path into the flush path. The amount branched out into the flush path can be adjusted using a throttle integrated into the flush path.

Moreover, a pump assembly for alternative fuels, in particular for methanol or ammonia, is proposed. The pump assembly comprises a pre-feed pump and a high-pressure pump, wherein the pre-feed pump is integrated into a feed path of a low-pressure circuit, via which fuel can be supplied to at least one pump element of the high-pressure pump, and wherein the low-pressure circuit comprises a return path for discharging fuel that occurs by way of leakage in the at least one pump element. According to the present invention, a cooling path branches off from the feed path, which leads through at least one cooling element that is integrated into a suction chamber and/or into a leakage chamber of the high-pressure pump.

The proposed pump assembly is particularly suitable for carrying out the method according to the invention described above, or may be operated according to the method, so that the same advantages can be achieved. In particular, the high-pressure pump and/or the amount of leakage to be discharged via the return path may be cooled with fuel from the feed path. The cooling prevents the fuel in the intake area of the high-pressure pump and/or in the return path from changing its physical state from liquid to gaseous, depending on where the at least one cooling element is integrated into the high-pressure pump, into the suction chamber and/or into the leakage chamber. Advantageously, a cooling element is integrated in both the suction chamber and the leakage chamber.

The at least one cooling element can in particular be designed as a conduit or tube that is guided through the suction chamber and/or the leakage chamber. Preferably, the at least one cooling element penetrates the suction chamber and/or the leakage chamber so that it is surrounded on all sides by fuel. In this way, a maximum heat transfer surface is created. To further improve the heat transfer, the at least one cooling element may comprise an outer contour that increases the surface area and/or be made of a material that has a high thermal conductivity.

The cooling path preferably branches downstream of the pre-feed pump and upstream of a metering unit from the feed path. The pre-feed pump can thus be used to convey fuel via the cooling path, and the amount of fuel metered by the metering unit remains unaffected.

In further development of the invention, it is proposed that a cooling device is integrated into the feed path, preferably downstream of the pre-feed pump and upstream of the branching cooling line. With the help of the cooling device, the fuel can be cooled down before it is diverted into the cooling path so that the cooling effect is increased. For example, the cooling device may be a heat exchanger integrated into a cooling circuit that is flowed through by a coolant of the cooling circuit.

According to a preferred embodiment of the invention, the cooling path downstream of the at least one cooling element opens into a fuel storage tank or upstream of the pre-feed pump into the feed path. The fuel is thus still available.

Further preferably, a pressure holding valve is integrated into the return path and/or the cooling path. The pressure holding valve may be used to maintain a minimum pressure that prevents a change in the aggregate state of the fuel from liquid to gaseous even if the fuel temperature is increased. Ideally, the fuel is depressurized to ambient pressure only shortly before the tank.

Furthermore, it is proposed that a flush path branches off from the cooling path and is connected to the leakage space and/or the return path via the at least one pump element. With the help of the fuel branched off into the flush path, the at least one pump element can be flushed, so that the discharge of the leakage amount is promoted. For example, the flush path may branch off from the cooling path between two cooling elements. Preferably, a throttle is integrated into the flush path. Using the throttle, the flush amount can be set.

### BRIEF DESCRIPTION OF THE DRAWINGS

Preferred embodiments of the invention are described in greater detail hereinafter with reference to the accompanying drawings. Shown are:

FIG. 1 a schematic illustration of a first pump assembly according to the invention and

FIG. 2 a schematic illustration of a second pump assembly according to the invention,

### DETAILED DESCRIPTION

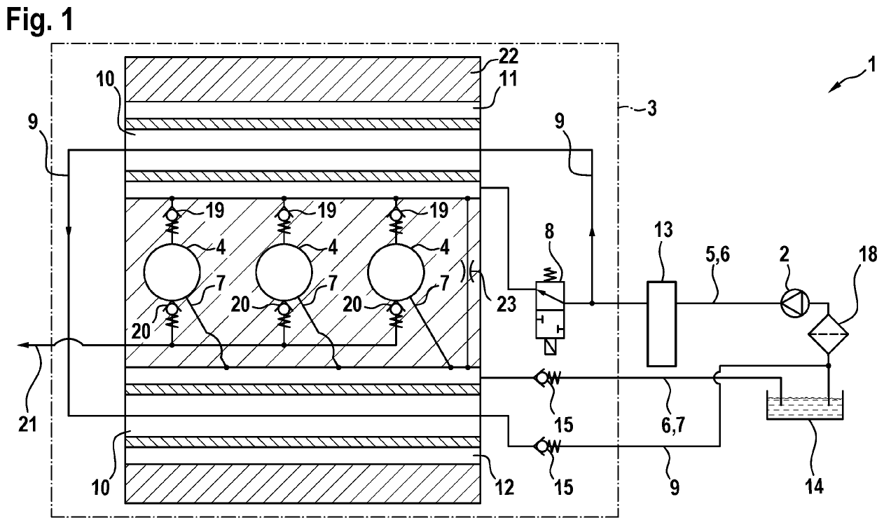

FIG. 1 shows a pump assembly 1 according to the invention for alternative fuels, for example for methanol. The pump assembly 1 comprises a pre-feed pump 2 and a high-pressure pump 3. With the aid of the pre-feed pump 2, the fuel is withdrawn from a tank 14 and supplied to at least one pump element 4 of the high-pressure pump 3 via a feed path 5. In the present case, the high-pressure pump 3 shown comprises three pump elements 3, wherein the number is selected by way of example only. Upstream of the pre-feed pump 2, a filter 18 is integrated into the feed path 5, which is intended to remove harmful particles from the fuel.

Downstream of the pre-feed pump 2, a metering unit 8 is integrated into the feed path 5, by means of which the fuel is metered. The supply of the individual pump elements 4 with fuel is provided via suction valves 19 associated with the pump elements 4. The pump elements 4 are connected to a suction chamber 11 of the high-pressure pump 3 via the suction valves 19, into which the feed path 5 opens. The fuel supplied to the pump elements 4 via the suction valves 19 is conveyed at high pressure and is discharged via high-pressure valves 20 into a high-pressure conduit 21. Fuel produced as leakage during high-pressure conveyance is discharged via a return path 7, which passes through a leakage chamber 12 of the high-pressure pump 3 and opens into the tank 14. The feed path 5 and the return path 7 together form a low-pressure circuit 6. A connection bypassing the pump elements 4 is established between the feed path 5 and the return path 7 via a zero-feed restriction 23.

From the feed path 5, a cooling path 9 branches off downstream of the pre-feed pump 2 and upstream of the metering unit 8, which is routed for cooling the high-pressure pump 3 and the leakage amount via a first cooling element 10 integrated into the suction chamber 11 and a second cooling element 10 integrated into the leakage chamber 12. To increase the cooling effect, a cooling device 13 is integrated into the feed path 5 upstream of the branching cooling path 9. The cooling path 9 opens back into the feed path 5 upstream of the pre-feed pump 2, so that the fuel which is branched off for cooling is not lost.

In the present case, a pressure holding valve 15 is integrated in the return path 7 as well as in the cooling path 9. These may be arranged inside or outside a housing 22 of the high-pressure pump 3. With the help of the pressure holding valves 15, a minimum pressure can be maintained in the return path 7 and in the cooling path 9.

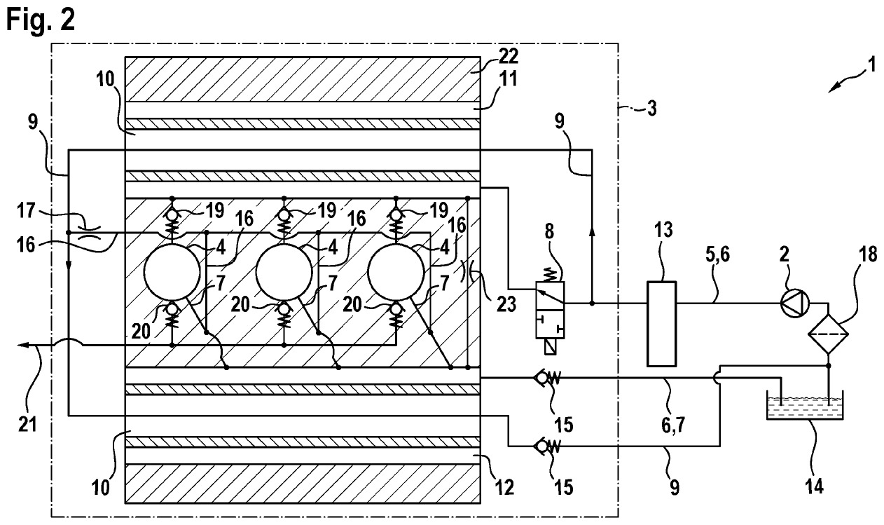

FIG. 2 shows a further pump assembly 1 according to the invention with a pre-feed pump 2 and a high-pressure pump 3. It differs from that of FIG. 1 only in that a flush path 16 for flushing the pump elements 4 is additionally provided. Flushing promotes the discharge of leakage amounts. The flush path 16 branches off from the cooling path 9 between the two cooling elements 10. The flush amount is set via a throttle 17 integrated in the flush path 16.

Since the flush path 16 branches off from the cooling path 9, further cooling can be achieved with the aid of the flush amount.

1. A method for operating a pump assembly (1) for alternative fuels comprising a pre-feed pump (2) and a high-pressure pump (3), wherein, with the pre-feed pump (2), fuel is supplied to at least one pump element (4) of the high-pressure pump (3) via a feed path (5) of a low-pressure circuit (6), and fuel produced by leakage in the at least one pump element (4) is discharged via a return path (7) of the low-pressure circuit (6),
wherein from the feed path (5) fuel is branched off into a cooling path (9) and supplied to at least one cooling element (10), which is integrated into a suction chamber (11) and/or a leakage chamber (12) of the high-pressure pump (3).

2. The method according to claim 1,
wherein the fuel branched off into the cooling path (9) is previously cooled using a cooling device (13) integrated into the feed path (5).

3. The method according to claim 1,
wherein the fuel branched off into the cooling path (9) and supplied to the at least one cooling element (10) is returned to a tank (14) storing the fuel or to the feed path (5) upstream of the pre-feed pump (2).

4. The method according to claim 1,
wherein in the return path (7) and/or in the cooling path (9), a predefined minimum pressure level is set using a pressure holding valve (15).

5. The method according to claim 1,
wherein fuel is branched off from the cooling path (9) into a flush path (16) and supplied to the at least one pump element (4) for discharging the fuel produced by leakage.

6. A pump assembly (1) for alternative fuels, the pump assembly comprising a pre-feed pump (2) and a high-pressure pump (3), wherein the pre-feed pump (2) is integrated into a feed path (5) of a low-pressure circuit (6), via which fuel can be supplied to at least one pump element (4) of the high-pressure pump (3), and wherein the low-pressure circuit (6) comprises a return path (7) for discharging fuel produced by leakage in the at least one pump element (4),
wherein, from the feed path (5), cooling path (9) branches off, which leads to at least one cooling element (10) integrated into a suction chamber (11) and/or into a leakage chamber (12) of the high-pressure pump (3).

7. The pump assembly (1) according to claim 6,
wherein cooling device (13) is integrated in the feed path (5).

8. The pump assembly (1) according to claim 6,
wherein the cooling path (9) opens downstream of the at least one cooling element (10) into a tank (14) storing the fuel, or upstream of the pre-feed pump (2) into the feed path (5).

9. The pump assembly (1) according to claim 6,
wherein pressure-holding valve (15) is integrated in the return path (7) and/or in the cooling path (9).

10. The pump assembly (1) according to claim 6,
wherein, from the cooling path (9), a flush path (16) branches off, which is connected via the at least one pump element (4) to the leakage chamber (12) and/or the return path (7).

11. The method according to claim 1, wherein the alternative fuels are methanol or ammonia.

12. The method according to claim 1, wherein fuel is branched from the feed path (5) downstream of the pre-feed pump (2) and upstream of a metering unit (8) integrated in the feed path (5).

13. The method according to claim 5, wherein fuel is branched off from the cooling path (9) between two cooling elements (10).

14. The method according to claim 5, wherein an amount branched off into the flush path (16) is set using a throttle (17) integrated into the flush path (16).

15. The pump assembly according to claim 6, wherein the alternative fuels are methanol or ammonia.

16. The pump assembly according to claim 6, wherein fuel is branched from the feed path (5) downstream of the pre-feed pump (2) and upstream of a metering unit (8) integrated in the feed path (5).

17. The pump assembly according to claim 7, wherein the cooling device (13) is integrated in the feed path (5) downstream of the pre-feed pump (2) and upstream of the cooling path (9).

18. The pump assembly according to claim 10, wherein fuel is branched off from the cooling path (9) between two cooling elements (10).

19. The pump assembly according to claim 10, wherein a throttle (17) is integrated into the flush path (16).
